(19) United States
(12) Patent Application Publication
(10) Pub. No.: US 2011/0283756 A1
(43) Pub. Date: Nov. 24, 2011

(54) DEVICE FOR CREATING A SABOTAGE PROTECTING CONTACT COMPONENT

(76) Inventor: Hans Nilsson, Vastervik (SE)

(21) Appl. No.: 13/133,969

(22) PCT Filed: Dec. 11, 2009
(86) PCT No.: PCT/SE2009/000512

§ 371 Date: Jul. 27, 2011

(30) Foreign Application Priority Data
Dec. 11, 2008 (SE) 0802553-8

(51) Int. Cl. E05B 49/02

(52) U.S. Cl. 70/278.1

(57) ABSTRACT

The present disclosure relates to a device for creating a sabotage protecting contact component (1), arranged in a locking function (2) near, on or in a lockable unit (3), e.g. a door, a window, a hatch or a gate, in order to relock from the outside a space or enclosure (4), said contact component (1) transmits via electric cables (5) electric current to the locking function (2) in the form of an electronic code, which activates an electronic part (6) and/or activates the mechanical part (7) of the locking function (2) for transmitting the current to drive a unit, e.g. a solenoid for connecting the mechanical part to a rotary function, e.g. a knob or a handle for locking or unlocking the lockable unit (3) by means of a lock cylinder, for example. Said contact component (1) has a cylinder (9) or a tubular formation (8), which is enclosed by a number of tubular formations (8) of increasing diameter, which, by means of a press fit, are inserted in each other in an axial direction (13), every other tubular formation (8) of which or the cylinder (9) is a current conducting tubular formation (10) for transmitting the electric current or is an electrically insulating tubular formation (26), which tubular formations (8) have a visible end (14), which extends in a planar direction and transversely to the axial longitudinal direction (13), having electrical contact surfaces (16) for receiving current from a current transmitting contact unit (17) applied from outside against the contact surfaces (16).

The present invention relates to a device for creating a sabotage protecting contact component for a locking function, which is arranged in a lockable unit. The contact component transmits electrical current to the locking function via electric cables. According to the invention the contact component comprises a cylinder enclosed by tubular formations of increasing diameter, every other one being current conducting and every intervening one being insulating for transmission of the electric current, the envelope surfaces and inner walls of which are joined together by means of a press fit and inserted one inside the other in the axial direction, having a flat visible end across their axial length to create an electrical contact surface.

In structures of the type in question currently on the market, locking functions are used for lockable units such as doors, windows, hatches and gates to relock a space. The locking function is provided with a contact component, which transmits current in the form of a code, or for driving a solenoid, which activates a mechanical part in the locking function, e.g. a lock cylinder, for locking or unlocking the locking function. To prevent locking functions such as those described above from supplying its current requirements via electric cables laid to the lockable unit, e.g. an outer door through a frame section/rebate within the door, the contact component is accessible to sabotage from the outside of the lockable unit. Conventional contact components are therefore easy to sabotage. They have holes in which tools can easily be inserted and which easily admit water, which destroys the contact component. The exposed contact surfaces are often made of metal material that is too thin and of parts that can easily be detached from the outside and have profiled contact surfaces, which are vulnerable and can be prized open with a tool. These problems are described in DE 10062464 A1, U.S. Pat. No. 6,042,417 and U.S. Pat. No. 5,385,039. According to WO 2006/1112615 A1, the contact component also has sharply profiled contact surfaces for transmitting a torque with a key function, which surfaces are particularly sensitive to sabotage.

The object of the present invention is to solve the problems associated with the above-mentioned structures in providing a tight, sabotage protecting and impact resistant contact component, which is formed around a cylinder, enclosed by tubular formations of increasing diameter, which are inserted into each other with a press fit in an axial direction to form one unit in order to produce a homogeneous sabotage protecting contact component which can be used in a locking function for a lockable unit. Current is transmitted via a current transmitting contact unit applied from the outside in electrically conducting tubular formations for the locking function in order to actuate the lockable unit.

Thanks to the invention a simple, low cost, efficiently operating and sabotage protecting contact component has been provided, which is difficult to sabotage. The contact component is arranged in a locking function, which is arranged in a lockable unit such as a door, a window, a hatch or a gate in order to relock a space or enclosure from the outside. The contact component points away from the locking function and is accessible to a user to transmit electric current via electric cables to the locking function to activate an electronic part by means of an electronic code, which activates the mechanical part of the locking function for transmitting the current to drive a solenoid, which connects the mechanical part to a knob, handle or key accessible from outside, which, when activated from the outside by a user, locks or unlocks the lockable unit by means of a lock cylinder, for example. According to the invention the contact component has a cylinder and a tubular formation in the centre of the contact component, which cylinder or formation is enclosed by a number of tubes or tubular formations inserted into each other in an axial direction by means of a press fit, e.g. in a hydraulic press, which formations are compressed with force to become positionally fixed to each other. The tubular formations have gradually increasing diameters, every other tubular formation and the cylinder being current conducting or insulating for the transmission of the electric current in the current conducting tubular formations or the cylinder, whose envelope surfaces and inner walls are then positionally fixed in providing a sabotage protecting contact component in which the current conducting tubular formations are electrically insulated from each other with tubular formations which are electrically insulating. The joint between the tubular formations will be homogeneous, tight and impact resistant and difficult to drill through. The contact component has a visible end, which extends in the planar direction transversely to the axial longitudinal direction, having electrical contact surfaces for receiving the current transmitted from and to the contact surfaces from the applied current transmitting contact unit applied by a user who is to lock or unlock the locking function. Since the tubular formations and the cylinder are current conducting, they are made of metal, and since they are electrically insulating they are made of plastic. The envelope surfaces and inner walls of the tubular formations are fixed to each other by friction or gluing. The contact component of course can be designed of any number of tubular formations to obtain the desired number of electrically conducting contact surfaces.

In a preferred embodiment of the invention, the end, which is visible after that the tubular formations has been joined together, is ground down to form a completely smooth, flat surface to avoid elevations that would facilitate sabotage. The other end, called the concealed end, is anchored and permanently arranged somewhere in the locking function, pointing away from it in the axial direction of the contact component and having a homogeneous length in the axial direction and a diameter of at least 10 mm in the sabotage protecting contact component. The thickest tubular formation is of metal but is not used as current conducting. At its concealed end it has a bottom surface which extends in the planar direction transversely to the axial direction and which is produced together with the envelope surface to make the contact component more difficult to force. This bottom surface has holes for the electric cables, which are contacted in the current conducting tubular formations and the cylinder if it is also current conducting. The cylinder, which may be solid or hollow, may be pushed through the bottom surface in a hole in the surface, so that it can anchor the concealed end at the end of the cylinder.

In the preferred variant of the invention the locking function is enclosed by a sabotage protecting cover made of sheet steel, which is permanently arranged in the outside of the unit with fastening parts extending through the lockable unit, assembled from inside the space, and are then inaccessible from the outside of the cover. The cover has a hole, in which the concealed end is inserted, approx. 5-30 mm, and is in this position permanently fitted in the cover from the inside by means of a fastening device which is not visible or accessible from outside the cover. The visible end projects approx. 1-5 mm outside the outer surface of the surrounding cover.

In a first variant of the invention the outermost tubular formation of the contact component is surrounded with the largest diameter by a mechanically protecting sleeve with a bottom that has a hole for the electric cables. The sleeve is made of a non-electrically conducting material, e.g. impact resistant plastic, which covers and encloses the concealed end and extends as far as the inside of the cover to provide mechanical protection for mitigating damage to the contact component, e.g. by a drill bit that is drilled obliquely through the case against the contract component. The outermost tubular formation has a diameter that is minimally less than the diameter of the hole in the cover, except at the visible end of the contact component, whose diameter is larger (1-5 mm) for the formation of a flange around the envelope surface, extending radially with a thickness of approx. 1-5 mm in the axial direction. The flange is then in contact with the outer surface of the cover. The contact itself then constitutes a support against the fastening device, which is pressed against the outer surface of the cover when the fastening device clamps against it. The sleeve has an upper edge, which is in contact with the inside of the cover. The concealed end at its centre has a threaded rod permanently arranged there, the end of which is secured in at least one of the bottom surfaces of the tubular formations or in the end of the cylinder pointing in the axial direction away from the concealed end. A hole is made in the bottom surface of the sleeve to provide space for inserting the threaded rod so that it points through it. A small interval between the bottom of the sleeve and the bottom surface of the largest tubular formation provides space for tightening a tightening nut, whereupon the interval is reduced causing the edge of the sleeve to be clamped to the inside of the case. The flange is then clamped with the support against the outer surface and the edge of the sleeve is clamped to the inside of the cover. To reduce the risk of sabotage with a tool against the flange, the outer surface of the cover and the flange are countersunk in an area immediately surrounding the flange approx. 1-10 mm in the radial direction corresponding to the thickness of the flange.

In a further variant of the invention the risk of sabotage of the contact component is reduced by arranging a protecting element close to a bottom surface inside one of the tubular formations or the cylinder. The protecting element then consists of a hardened steel ball with a diameter of several mm, or a cylindrical hardened steel rod of the same diameter and several mm long. This is encapsulated in a mass or compound such as glue, butyl or silicone for stopping a tool, e.g. a drill bit, for sabotaging the threaded screw in a sabotage operation and loosening the contact component.

The most significant advantages of the invention will therefore include the fact that a simple, low cost, easy to manufacture contact component that is difficult to force has been provided. The tubular formations and the cylinder are joined together by a special technique (press fitting), which provides a homogeneous, tight contact component that is difficult to force and can be anchored in the locking function behind an impact resistant, protecting cover for preventing the locking function from opening. The contact component can be provided with any number of tubular formations for obtaining the desired number of contact surfaces.

The invention is described more in detail below by means of one or two exemplary embodiments of the invention, where

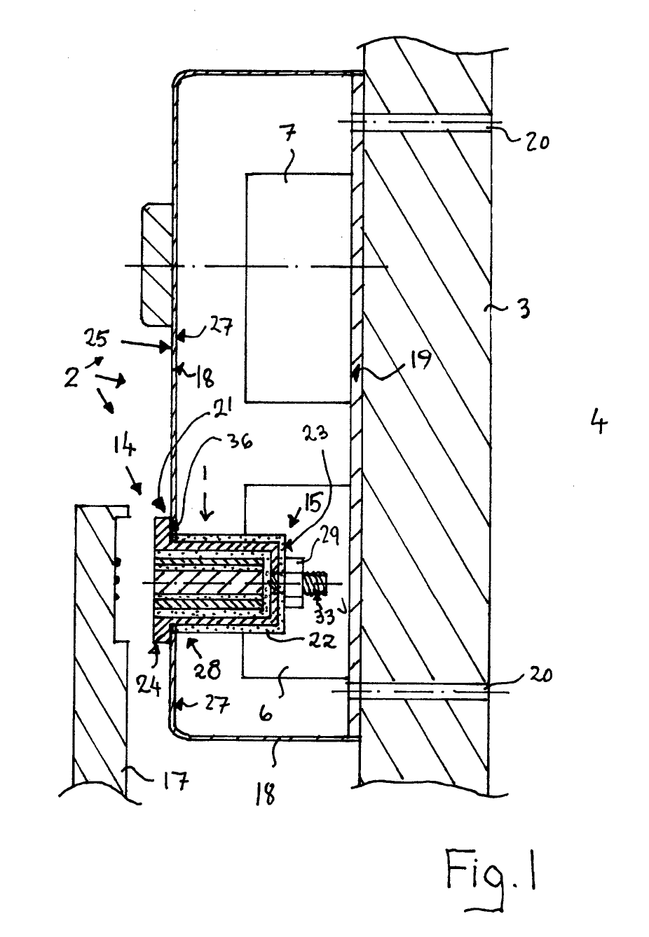

FIG. 1 shows a vertical section in the axial direction through a contact component arranged in a cover, encapsulated in a sleeve, in a lockable unit,

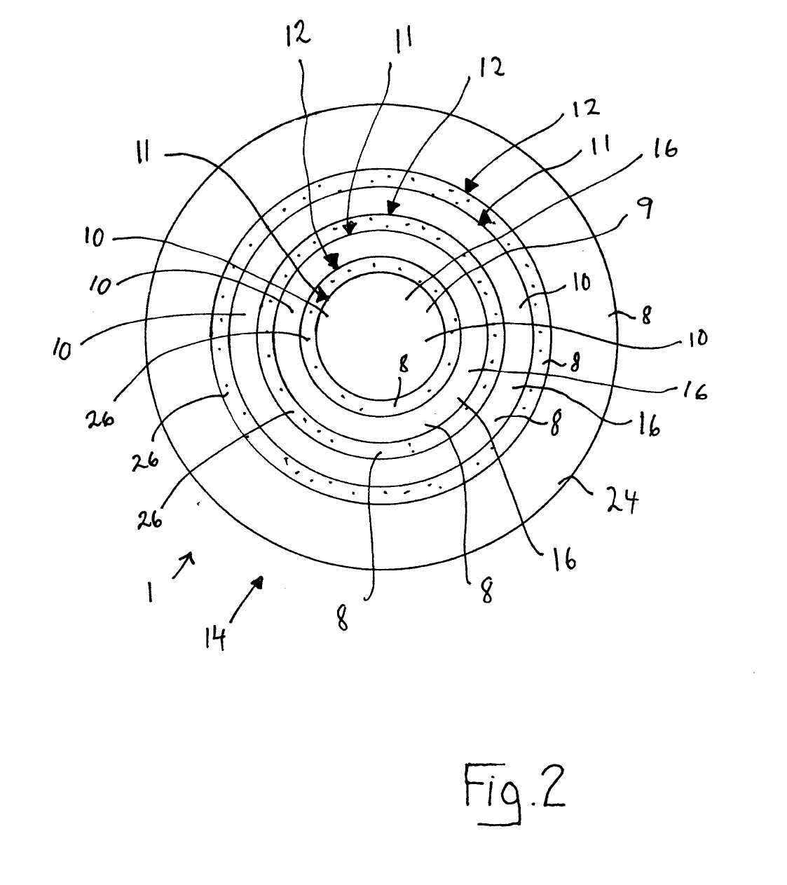

FIG. 2 shows a view of the visible part of the contact component viewed directly facing the contact surfaces towards the outside of the cover, and

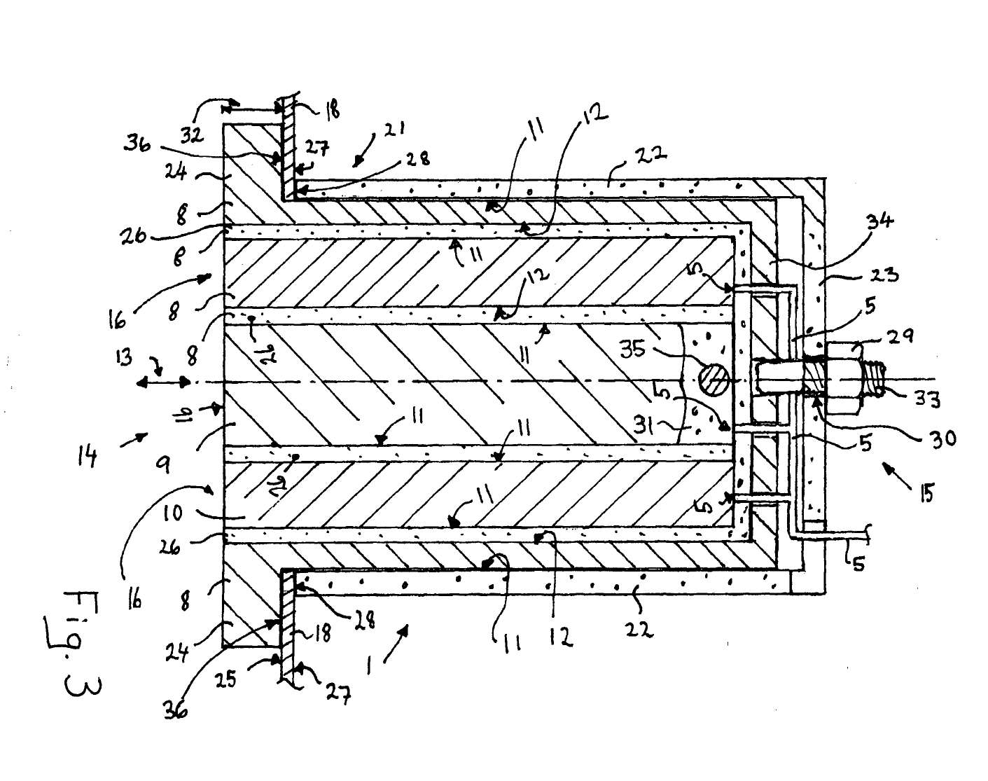

FIG. 3 shows a vertical section through the contact component in an axial direction and a part of the case.

As is evident from FIGS. 1-3, a contact component 1 is shown here arranged in a locking function 2, in a lockable unit 3, for relocking from the outside a space or an enclosure 4. The contact component 1 transmits via electric cables 5 electric current to the locking function 2, which activates an electronic part 6 and a mechanical part 7 of the locking function 2 for locking or unlocking the lockable unit 3, e.g. via a lock cylinder. The contact component 1 has a cylinder 9 at its centre or a tubular formation 8 with gradually increasing diameters, which is enclosed by a number of tubular formations 8 inserted into each other by means of a press fit in an axial direction 13 with their envelope surfaces 11 and inner walls 12 positionally fixed to each other, the cylinder 9 of which, and every other tubular formation 8, form a current conducting tubular formation 10, and every one in between form an electrically insulating tubular formation 26. The contact component 1 has a visible end 14, which extends in the planar direction transversally to the axial longitudinal direction 13, having electrical contact surfaces 16 to receive the current from a current transmitting contact unit 17 applied to the contact surfaces 16. The outermost tubular formation 8 has at its other end a concealed end 15. A bottom surface 34 is arranged there which extends in the planar direction transversely to the axial longitudinal direction 13. The bottom surface 34 has holes for electric cables 5, which are contacted to the current conducting tubular information 10, and the cylinder 9. The concealed end 15 is permanently arranged inside the locking function 2. The locking function 2 is enclosed by a sabotage protecting cover 18, which is permanently arranged on the outside 19 of the lockable unit 3 with fastening parts 20. The cover 18 has a hole 21, in which the concealed end 15 is inserted. The outermost tubular formation 8 has at its visible end 14 a flange 24 around the envelope surface 11, extending radially, with a thickness 32 in contact with an outer surface 25 of the cover 18, constituting a support 36 there. He outermost tubular formation 8 is surrounded by a mechanically protecting sleeve 22 with a bottom 23 having a hole for electric cables 5. The sleeve 22 is made of a non-electrically conducting material, which covers and encloses the concealed end 15 up to the inside 27 of the cover, where it has an upper edge 28 contacting the inside 27 of the cover and the concealed end 15 has a firmly mounted threaded rod 33, fastened to the bottom surface 34 pointing in the axial direction 13 away from it, having a tightening nut 29. The sleeve 22 and the bottom surface 34 is provided with a hole 30 for the threaded rod 33 to point through. The tightening nut 29 can be drawn downwards to the bottom 23 and the bottom surface 34, so that the upper edge 28 in this way is pressed against the inside 27 and the flange 24 is pressed to outer surface 25 and the support 36, so that together they constitute a fastening device. The end of threaded rod 33 is fastened in concealed end 15, having a protecting element 35, encapsulated in a mass 31 close to the bottom surface 34 inside the cylinder 9 for preventing a tool e.g. a drill bit from loosening the threaded rod 33 in a sabotage action.

1. A device for creating a sabotage protecting contact component arranged in a locking function near, on or in a lockable unit, e.g. a door, a window, a hatch or a gate, in order to relock from the outside a space or enclosure, said contact component transmits via electric cables electric current to the locking function in the form of an electronic code, which activates an electronic part and/or activates an mechanical part of the locking function for transmitting the current to drive a unit, e.g. a solenoid for connecting the mechanical part to a rotary function, e.g. a knob or a handle for locking or unlocking the lockable unit by means of a lock cylinder, for example, wherein the contact component has a cylinder or a tubular formation, which is enclosed by a number of tubular formations of increasing diameter, which, by means of a press fit, are inserted in each other in an axial direction, every other tubular formation of which or the cylinder is a current conducting tubular formation for transmitting the electric current or is an electrically insulating tubular formation, which tubular formations have a visible end, which extends in a planar direction and transversely to the axial longitudinal direction, having electrical contact surfaces for receiving current from a current transmitting contact unit applied from outside against the contact surfaces.

2. The arrangement according to claim 1, wherein the visible end is smooth and flat, e.g. produced by grinding, and in that its other concealed end, which is positionally fixed inside the locking function, points in the axial direction of the contact component away from the function, having a homogeneous length in the axial direction and a diameter of at least 10 mm in the sabotage protecting contact component.

3. The device according to claim 1, wherein when the tubular formation or cylinder is current conducting, they are made of metal, and when they are electrically insulating they are made of plastic or metal, and in that the envelope surfaces of the cylinder or tubular formations and the inner walls of the tubular formations are fixable to each other by friction and/or gluing.

4. The device according to claim 1, wherein at least one of the tubular formations closest the concealed end has a bottom surface, which extends in the planar direction transversely to the axial direction to reduce the risk of sabotage and render the contact component more difficult to force, which bottom surface has openings for the electric cables, which are contacted in the current conducting tubular formations or the cylinder, which bottom surface has a hole for insertion of the cylinder or is entirely without this hole.

5. The device according to claim 1, wherein the locking function is enclosed by a sabotage protecting cover made of sheet steel, which is permanently arranged in, near, on or against the outside of the lockable unit with fastening parts extending through the lockable unit, mounted from inside the space and not accessible from the outside, which cover has at least one hole into which the concealed end is inserted, approx. 5-30 mm, and is permanently mounted from the inside near the cover by means of at least one fastening device, and is not accessible from outside, which visible end projects approx. 1-5 mm outside the outer surface of the surrounding cover.

6. The device according to claim 4, wherein the outermost tubular formation of the contact component, with the largest diameter, is surrounded by a sleeve protecting against mechanical damage and having a bottom that has at least one opening for the electric cables, which sleeve is made of a non-electrically conducting material, e.g. impact resistant plastic, which covers and encloses the concealed end and which extends up to the inside of the cover.

7. The device according to claim 5, wherein the outermost tubular formation has a minimally smaller diameter than the diameter of the hole, except at the visible end, whose diameter is larger (1-5 mm) for the formation of a flange around the envelope surface, extending radially, with a thickness in the axial direction of approx. 1-5 mm, which flange is in contact with the outer surface of the cover, constituting a support for the fastening device when it is tightened.

8. The device according to claim 6, wherein the outer surface of the cover, in an area immediately surrounding the flange, approx. 1-10 mm in the radial direction, is countersunk, viewed from the outside, essentially corresponding to the thickness, to reduce accessibility for a tool for sabotaging the contact component.

9. The device according to claim 5, wherein the sleeve has at least one upper edge, which is in contact with the inside of the cover, and in that the concealed end, at its centre, has a threaded rod permanently arranged there, whose end is fastened in at least one of the bottom surfaces or the cylinder, pointing in the axial direction away from the concealed end, having at least one tightening nut, which sleeve or at least one bottom surface has the hole for the threaded rod to poke through, which tightening nut can be tightened in the direction of the bottom, which upper edge is then clamped to the inside and the flange is clamped to the outer surface constituting the support, which threaded rod, tightening nut, edge, inside, surface and flange together constitute the fastening device.

10. The device according to claim 9, wherein the end of the threaded rod, which is fastened in the concealed end, has at least one protecting element in the form of a hardened steel ball, for example, with a diameter of a several mm, or a cylindrical hardened steel bar with the same diameter, and which is several mm long, is encapsulated in a mass such as glue, butyl or silicone, arranged close to at least one bottom surface inside at least one tubular formation, or inside the cylinder, in order to prevent a tool from destroying the threaded rod in an act of sabotage.
